(19) United States
(12) Patent Application Publication
(10) Pub. No.: US 2013/0085714 A1
(43) Pub. Date: Apr. 4, 2013

(54) Method and device for moving a sensor close to a surface

(71) Applicant: Trek, Inc., Medina, NY (US)

(72) Inventors: Akiyoshi Itoh, Chiba (JP); Katsuji Nakagawa, Tokyo (JP); Yoshito Ashizawa, Chiba (JP); Jumpei Higashio, Tokyo (JP); Toshio Uehara, Tokyo (JP); Bruce Williams, Barker, NY (US); Tomoharu Saito, Chiba (JP)

(73) Assignee: Trek, Inc., Medina, NY (US)

(21) Appl. No.: 13/573,731

(22) Filed: Oct. 3, 2012

Related U.S. Application Data
(60) Provisional application No. 61/542,648, filed on Oct. 3, 2011.
(60) Provisional application No. 61/593,837, filed on Feb. 1, 2012.

(51) Int. Cl. G01B 7/14; G06F 15/00

(52) U.S. Cl. 702/150

(57) ABSTRACT

A method and a system for positioning a sensor of an electrostatic force microscope is disclosed. In a method according to the invention, the AC bias voltage and DC bias voltage systems of the EFM are utilized to determine a sensor sensitivity “G”, which is then used to adjust the position of the sensor or the AC bias voltage in a manner that reduces the risk of arcing and/or contact between the sensor and the surface to be analyzed.

### CROSS-REFERENCE TO RELATED APPLICATION

This application claims the benefit of priority to U.S. provisional patent application Ser. No. 61/542,648, filed on Oct. 3, 2011, and to U.S. provisional patent application Ser. No. 61/593,837 filed on Feb. 1, 2012.

### FIELD OF THE INVENTION

The present invention relates to devices providing high spatial resolution results arising from high voltage measurements of a surface.

### BACKGROUND OF THE INVENTION

FIG. 1 schematically depicts an electrostatic force microscope (“EFM”) that is part of the prior art. EFMs are used to (among other things) determine the roughness of a surface, or to determine the charge variation on a surface. In this document, the surface being analyzed by the EFM is referred to as the “surface to be analyzed”, or “STBA” for short.

Prior to making measurements of an STBA, the tip of the sensor must be moved close to the STBA. As the tip of the sensor moves closer to the STBA, measurement quality increases. However, in doing so, the sensor may be moved too close to the STBA such that arcing and/or contact occurs between the sensor and the STBA. Such arcing and/or contact may damage the STBA. A means that reduces the risk of arcing is needed so that the position of the sensor can be made near enough to the STBA that highly accurate measurement operations can be made.

### SUMMARY OF THE INVENTION

The invention may be embodied as a method of positioning a sensor close to an STBA. Such a method may begin by providing an EFM and an STBA. The sensor tip of the EFM may be placed far enough from the STBA so that arcing and/or contact between the sensor and the STBA will not occur. With the sensor placed a distance (“D”) from the STBA, an AC bias voltage (“Vac”) may be applied to the sensor at an initial desired voltage (“Vd”). The sensor sensitivity (“G”) may be determined. G may be compared to a minimum sensor sensitivity Gmin. If G is less than Gmin, then Vac may be increased and G is again determined. If G is again less than Gmin, then the iterative process of increasing Vac and determining G is repeated until G is equal to or greater than Gmin.

If Gmin≦G<Gmax, then Vac may remain the same while the distance D is decreased. At the new D, G is determined, and if G is still less than Gmax, the iterative process of decreasing D and determining G is repeated until G is equal to or greater than Gmax.

If G÷Gmax, then Vac may be compared to a desired AC bias voltage Vd (which may be the same as the initial AC bias voltage) and if Vac is determined to be greater than Vd, Vac is decreased and G is again determined. If G is less than Gmax, then D is reduced, but if G is equal to or greater than Gmax, then Vac is again decreased. These steps are repeated (reducing D or reducing Vac) as needed to keep G close to (within a desired predetermined narrow range) Gmax until Vac is at or close to (within a desired predetermined narrow range) Vd. For example G may be considered close to Gmax if G is within 0.02×10⁻⁴ of Gmax, and Vac may be considered close to Vd if Vac is within 3 Volts of Vd. If G is approximately equal to (or close to) Gmax, and Vac is approximately equal to (or close to) Vd, then surface measurement operations with respect to the STBA using the sensor are begun.

The sensor sensitivity G may be determined by:
(a) setting a first DC bias voltage to the sensor at a desired voltage (“Vp”) that is greater than 0 Volts;
(b) using the sensor to detect a voltage V_{ω} and recording the detected V_{ω} as V1;
(c) setting a second DC bias voltage to the sensor at a desired voltage (“Vn”) that is less than 0 Volts;
(d) using the sensor to detect a voltage V_{ω} and recording the detected V_{ω} as V2;
(e) determining G, where G equals (V1−V2)÷(Vp−Vn).

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a schematic depiction of an EFM;

FIG. 2 is a schematic depicting the EFM as a parallel plate model;

FIG. 3 is a graph showing how V_{ω} changes with respect to the DC bias voltage Vdc;

FIG. 4 is a graph showing the dependency of the sensor sensitivity

G with respect to the distance D;

FIG. 5 is a flow chart depicting a method according to the invention;

FIG. 6 is a flow chart depicting a method according to the invention;

FIG. 7 is a flow chart depicting a method according to the invention for determining the sensor sensitivity G; and

FIG. 8 schematically depicts a system according to the invention.

### FURTHER DESCRIPTION OF THE INVENTION

We have invented a methodology for placing a sensor adjacent to an STBA, so that the sensor in a high spatial resolution/high voltage measurement apparatus can be used to accomplish voltage measurement, while simultaneously reducing the risk of arcing and/or contact between the STBA and the sensor. Generally speaking, we utilize two techniques: they are 1) providing an AC bias voltage to the sensor to nullify an electric field between the sensor and the STBA while the sensor approaches the STBA, and 2) adjusting the AC bias voltage to control the motion of the cantilevered sensor to be relatively constant even though the sensor is far from the STBA. Using these techniques, the sensor may be able to successfully approach a 500 Volt STBA without causing arcing and/or contact. In one embodiment of the invention, both the DC bias voltage system and the AC bias voltage system of the EFM may be used to position a sensor that starts at a distance that is large (for example, 1,000 μm) to bring the sensor to about 5 μm by adjusting the AC bias voltage to the sensor from a high AC bias voltage (for example, 200 Vₚ₋ₚ) to a lower AC bias voltage (for example, 12 Vₚ₋ₚ).

An EFM is highly susceptible to causing damage as a result of contact between the STBA and the sensor. The present invention may be used to bring the sensor of an EFM close to an STBA without the sensor contacting the STBA. Doing so may utilize both the DC and AC bias voltage systems of the EFM for (a) nullifying the electric field between the sensor and the STBA, and also (b) keeping the motion of the cantilevered sensor vibration nearly constant regardless of the position of the sensor relative to the STBA.

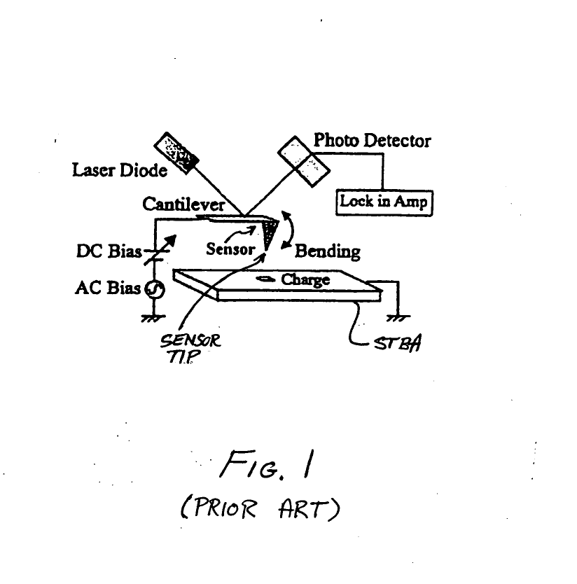

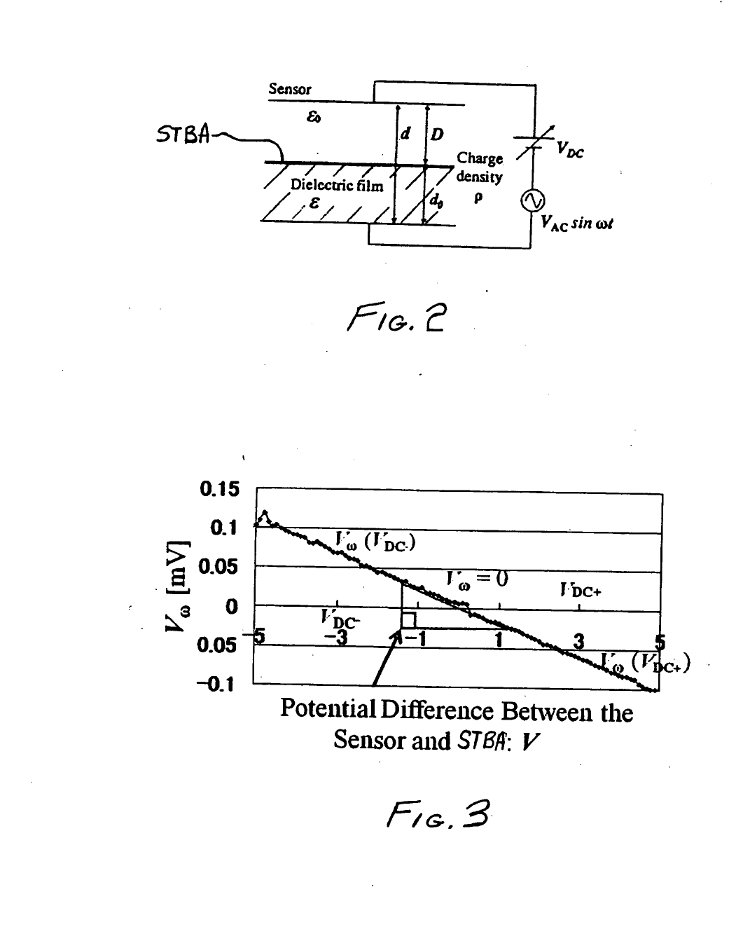

Basic Principles Of An EFM. In an EFM, the sensor is set on a cantilever of which motion is detected via an optical system. FIG. 1 depicts such an EFM. In order to analyze the STBA, the sensor is set close to an STBA. When both the DC bias voltage (V_{DC+} or V_{DC-}) and the AC bias voltage (V_{AC}) are applied to the sensor, a voltage V_{ω} on the STBA will either attract or repel the sensor. The electrostatic force existing between the charged STBA and the sensor can be detected by measuring the amount of bending of the cantilever using an optical detector, which may include a laser diode and a photo detector. The amount of bending can be correlated to the voltage V_{ω} on the STBA so that the EFM in effect provides an indication of the voltage V_{ω} on the STBA. If V_{AC} is sinusoidal (sin(cot)), an electrostatic force induced on the sensor has two different forces, namely F_{ω} and F_{2ω}. F_{ω} has the same frequency component as the applied AC bias voltage Vac, and F_{2ω} has twice the frequency component applied as the AC bias voltage Vac. FIG. 2 depicts a parallel plate model of an EFM to illustrate variables in the following two equations:

$$\begin{matrix}{F}_{ω} = \frac{{V}_{D C} - ρ {d}_{0} / {ɛ}_{0}}{{\{ d - ( 1 - {ɛ}_{0} / ɛ ) {d}_{0} \}}^{2}} {ɛ}_{0} {SV}_{A C} sin ω t & Equation \#1 \\ {F}_{2 ω} = - \frac{1}{4 {\{ d - ( 1 - {ɛ}_{0} / ɛ ) {d}_{0} \}}^{2}} {ɛ}_{0} {SV}_{A C}^{2} cos 2 ω t & Equation \#2\end{matrix}$$

We can measure F_{ω} by applying a known preset DC bias voltage V_{DC} to the sensor so that we can simply calculate the voltage on the STBA (pd₀/ε) with the aforementioned equation #1. With this foundation in mind, a method of the invention will now be explained more fully.

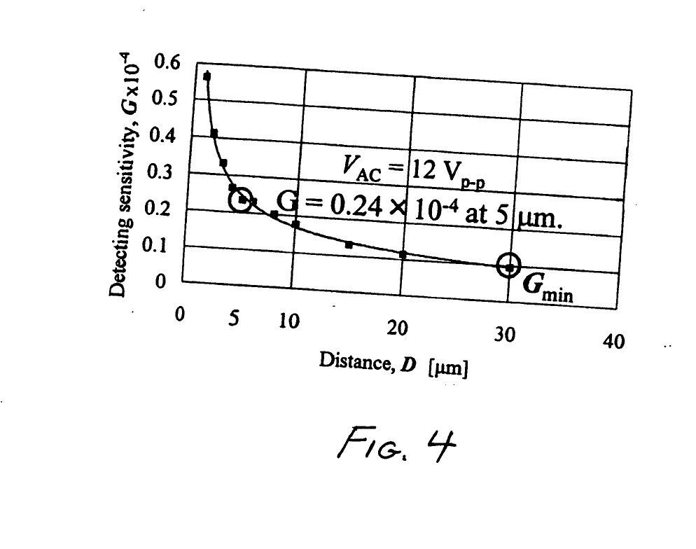

Using an EFM having a comb-shaped electrode, the voltage distribution on an STBA was analyzed and the results are plotted in FIG. 3. A bias voltage of 700 Volts was applied to the center electrode holding the STBA to the EFM. The other electrodes of the EFM were connected to the ground. 700 V could be measured without any arcing although the sensor was set very close to the STBA. If the signal obtained from the sensor V_{ω} was zero, the potential difference between the sensor and the STBA should have been zero. However, we were not able to practically obtain the signal to be zero due to the noise component of the measurement system. To overcome this problem, we identified an absolute zero voltage. In order to seek out the absolute zero voltage, we applied a few volts of positive and negative offset voltages shown as V_{DC+} and V_{DC-} respectively in FIG. 3. From the sensor voltage measurement V_{ω} and positive and negative voltage offset V_{DC+}, V_{DC-}, we were able to find the point of V_{ω}=0.

We were able to measure voltages V_{ω} up to +/−1 kV using the comb-shaped electrodes without arcing by utilizing this measurement method with a sensor located at a distance D=5 μm from the STBA. However, we realized that if the sensor was located far away from the STBA, we were not able to obtain adequate vibration of the cantilever since the sensor was too far from the STBA. In order to minimize the risk of arcing and/or contact between the STBA and the sensor by initially setting the sensor far from the STBA, a new method was needed. The method disclosed herein uses the sensor sensitivity G in conjunction with the distance D between the sensor and the STBA, and to accomplish this method, a minimum sensor sensitivity Gₘᵢₙ is used along with a sufficiently strong AC bias voltage signal Vac in order to guarantee adequate and accurate measurement. Even when the distance D is large, the minimum sensor sensitivity Gₘᵢₙ is attainable by increasing the AC bias voltage V_{AC}. Consequently, this method performs well even though the sensor is located far away from the STBA.

EFMs typically are employed to analyze an STBA by placing the sensor close to the STBA, and often the distance D is on the order of about 5 μm. At this distance, the signal to noise ratio (“S/N Ratio”) for the system is sufficiently high to produce accurate results. But, if the distance D is large, such that the sensor is far away from the STBA, the S/N Ratio decreases accordingly and it becomes difficult to know much about the STBA, in part because the sensor is not very sensitive to the STBA conditions at such distances. Thus, we define a variable G that is an indication of the sensor sensitivity that we find useful in moving the sensor toward the STBA while minimizing the risk of arcing. We define the sensor sensitivity G with the following equation:

$$G = \vert \frac{{V}_{ω} ( {V}_{D C +} ) - {V}_{ω} ( {V}_{D C -} )}{{V}_{D C +} - {V}_{D C -}} \vert$$

where V_{DC} is the DC bias voltage applied to the sensor and V_{ω}(V_{DC}) is the signal obtained while applying V_{DC}. For example, under a typical measurement condition (D=5 μm), G is in the range of 0.2×10⁻⁴ to 0.4×10⁻⁴, and G may vary depending on characteristics of each cantilevered sensor. For one such cantilevered sensor corresponding to FIG. 3, we found that G=0.23×10⁻⁴ at D=5 μm.

For a particular EFM, the dependency of G on D while D changes from 1 to 30 μm is shown in FIG. 4. This dependency was measured under the condition V_{AC}=12 Vₚ₋ₚ over a flat copper plate as the STBA. We found that the relationship between G and D is exponential. Using this relationship, an appropriate DC bias voltage V_{DC} may be selected and applied to the sensor when the sensor is located at the distance D. Prior to this measurement we obtained G=0.23×10⁻⁴ at D=5 μm. When the distance D was at 30 μm, we found that the G was approximately 0.1×10⁻⁴. We also tested other cantilevered sensors which may have higher sensitivity than the one that produced the data of FIG. 3, and we found that G was also approximately 0.1×10⁻⁴ at a distance D=70 μm. Thus, regardless of the particular cantilevered sensor of an EFM, it is reasonable to conclude that whenever G is greater than 0.1×10⁻⁴, it is possible calculate an appropriate V_{ω}=0 wherever the sensor is located.

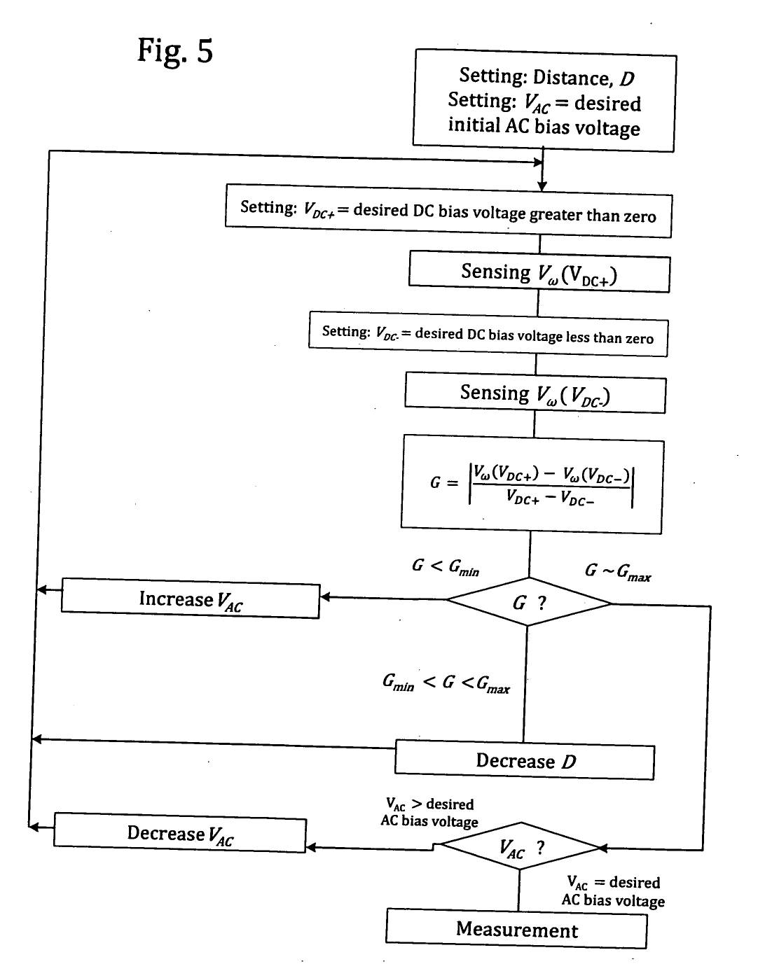

Having provided some details about the invention, we now move to describe the invention in more detail with the goal of clarifying the invention more fully. FIG. 5 is a flow chart that describes a method that is in keeping with the invention. In that method, an EFM having a cantilevered sensor is provided. An STBA is placed on a support surface of the EFM. Initially, the sensor is placed far enough from the STBA so that arcing and/or contact is not likely to occur, but also so that a Vac can be applied to the sensor at a level that results in the sensor being able to detect a charge on the STBA. For example, the distance D between the sensor and the STBA may be initially set at 1000 μm. The initial distance D may be measured and recorded for later use, but it may not be necessary to do so.

A resonance frequency in the form of an AC bias voltage Vac is applied to the sensor at a desired initial voltage. The desired initial AC bias voltage provided to the STBA may be selected so that the a detectable vibration on the cantilever is achieved. The initial AC bias voltage may be selected based on experience with the particular EFM and STBA being used. For example, the initial AC bias voltage may be 12 Volts peak-to-peak. With the distance D held to the initial value and the initial AC bias voltage applied to the sensor, the sensor sensitivity G of the sensor is determined. If the sensor sensitivity G is less than or equal to a minimum sensor sensitivity Gmin, the AC bias voltage is increased by an amount, and the sensor sensitivity G is again determined. The minimum sensor sensitivity Gmin may be 0.1×10⁻⁴.

If the sensor sensitivity G is still less than the minimum sensor sensitivity Gmin, the AC bias voltage is increased again, and this process is repeated until the sensor sensitivity G is equal to or greater than the minimum sensor sensitivity Gmin. When the AC bias voltage is increased as part of an effort to make the sensor sensitivity G greater than the minimum sensor sensitivity Gmin, the AC bias voltage may be increased by (for example) 5 Volts before the sensor sensitivity G is again determined and checked against Gmin.

Once the sensor sensitivity G is equal to or greater than the minimum sensor sensitivity Gmin, a comparison of the sensor sensitivity G is made to a maximum sensor sensitivity Gmax. Gmax may be selected to prevent arcing and/or contact between the sensor tip and the STBA. Also, Gmax may be selected to prevent damage to the cantilever and/or sensor caused by the vibration forces induced by the AC bias voltage signal. Typically, Gmax will be 2 to 100 times greater than Gmin. If the sensor sensitivity G is less than the maximum sensor sensitivity Gmax, then the distance D is decreased, and the sensor sensitivity G is again determined.

If the sensor sensitivity G is still greater than Gmin and less than Gmax, the distance D is decreased again, and this process is repeated until the sensor sensitivity G is equal to or greater than the maximum sensitivity Gmax. The change in the distance D may be (for example) 50 μm when G is greater than Gmin but less than Gmax. However, as G approaches Gmax, the incremental change in D may be reduced toward 1 μm.

Then, with the sensor sensitivity at or above Gmax, the AC bias voltage is compared to a desired AC bias voltage Vac, which may be the initial desired AC bias voltage Vd. If the AC bias voltage Vac is greater than the desired AC bias voltage, the AC bias voltage is decreased and the sensor sensitivity G is determined. If the sensor sensitivity G is at or above Gmax, then the AC bias voltage is again reduced, but if the sensor sensitivity is less than Gmax, then the distance D is decreased. When G is close to (within a desired predetermined narrow range) or above Gmax, the increments of Vac may be 5 Volts or less and the increments of D may be about 1 μm. Following either a reduction in AC bias voltage or a decrease in distance D, the sensor sensitivity is determined and this process continues until the sensor sensitivity G is equal to (or approximately equal to) Gmax and the AC bias voltage is equal to (or approximately equal to) the desired AC bias voltage Vd.

Once the sensor sensitivity equals (or is approximately equal to) Gmax and the AC bias voltage equals (or is approximately equal to) the desired AC bias voltage Vd, the sensor may be used to make measurements of the STBA. For example, the sensor may be caused to reside over different areas of the STBA, and the charge detected by the sensor may be recorded for each area of the STBA that is of interest. The measured charge for each area may be used to determine information about the STBA, such as the surface voltage distribution of the STBA.

FIG. 1 depicts a system for accomplishing the method described above. In FIG. 1, there is shown an STBA, a cantilevered sensor, a means for applying the DC bias voltage, and a means for applying the AC bias voltage. Along with the cantilevered sensor, the EFM depicted in FIG. 1 includes a laser diode and photo detector, which function together to detect deflection of the sensor caused by a charge on the STBA. This type of EFM will not be described in detail herein since it is a commonly available device and is well understood by those having skill in the art.

The sensor sensitivity G may be determined by setting the DC bias voltage to the sensor at a desired voltage (“Vp”) that is greater than 0 Volts. For example, Vn may be +3 Volts. Using the sensor, the voltage V_{ω} is detected and recorded as V1. Then the DC bias voltage to the sensor is set at a desired voltage (“Vn”) that is less than 0 Volts. For example, Vp may be −3 Volts. Using the sensor, the voltage is detected and recorded as V2. The order in which V1 and V2 are determined may be reversed—that is to say that V2 may be determined after V1. Having determined V1 and V2 at DC bias voltages Vp and Vn respectively, the sensor sensitivity may be determined using the following equation:

G=(V1−V2)—(Vp−Vn)

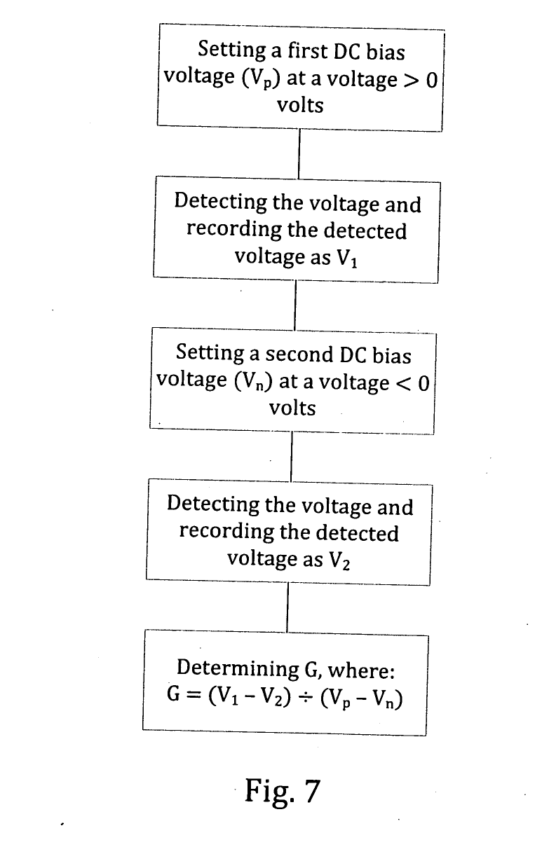

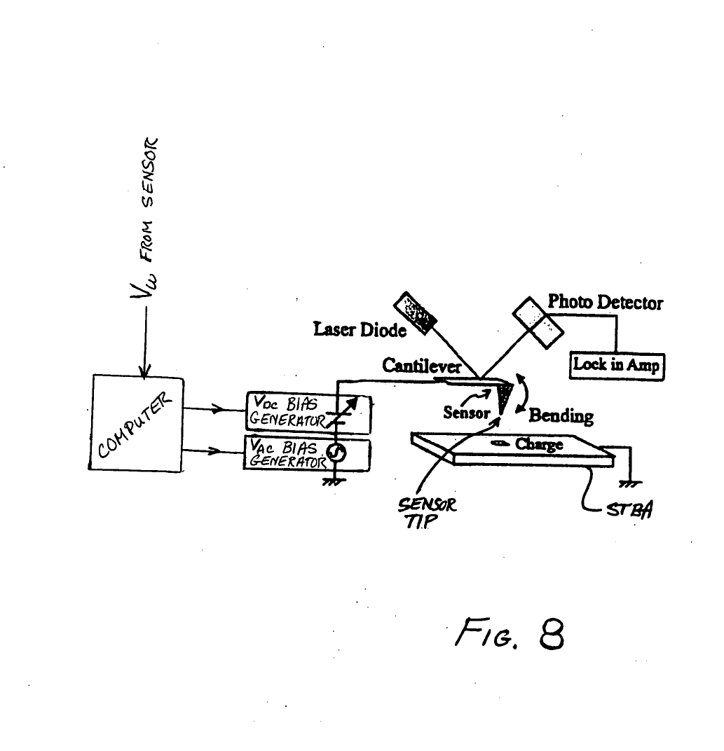

FIG. 7 graphically depicts the foregoing method.

It will now be realized that the chance of arcing and/or contact between the sensor tip and the STBA is reduced during the positioning of the EFM sensor tip near the STBA by a method and device that:
(a) initially places the sensor tip far enough from the STBA so that arcing and/or contact is very unlikely;
(b) the AC bias voltage is increased until the sensor sensitivity is equal to or greater than Gmin, and then;
(c) the distance D between the sensor tip and STBA is decreased until the sensor sensitivity is equal to or greater than Gmax, and then;
(d) the AC bias voltage Vac and distance D are reduced in a manner that keeps the sensor sensitivity close to (within a desired predetermined narrow range) Gmax until the AC bias voltage Vac is at a desired level Vd.

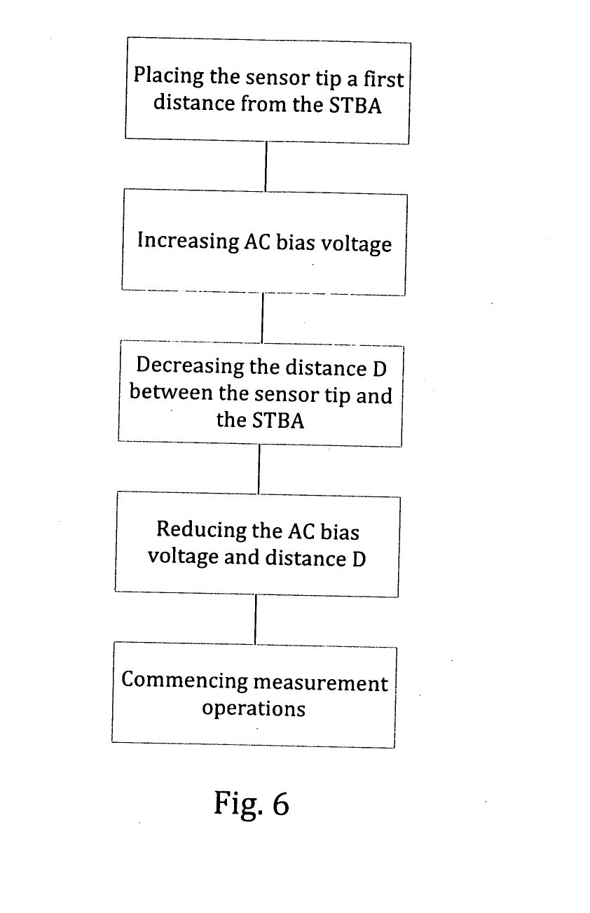

Once the sensor tip is placed near the STBA such that the AC bias voltage Vac is at a desired level Vd and the sensor sensitivity G is close to (within a desired predetermined narrow range) Gmax, measurement operations by the EFM are then undertaken with respect to the STBA. FIG. 6 if a flow chart depicting steps of such a method.

Ideally, there is a location of the sensor that will allow both (i) Vac to be equal to the desired AC bias voltage Vd, and (ii) G to be equal to Gmax. However, there may be a situation in which the ability of the EFM to increment D and the ability to increment Vac are not precise enough to achieve both Vd and Gmax. In that situation, that position of the sensor which achieves either Vd or Gmax may be selected, and the other variable may be allowed to be close to (within a desired predetermined narrow range) but not exactly at the desired value. For example, the distance D may be selected such that Vac is at the desired voltage Vd, even though G is not at Gmax. Or, the distance D may be selected such that G is at Gmax, even though Vac is not at the desired voltage Vd.

It should be noted that a computer may be used to store information needed to calculate G, and ultimately to calculate G. Also, the computer may be used to store information needed to execute the processes described herein. For example, the computer may be used to store information such as Gmin, Gmax, V1, V2, Vd, various V_{ω} readings, Vp and Vn. The computer may be programmed to execute a method according to the invention, and to that end the program may provide instructions to the computer to make comparisons and provide instructions to the EFM that result in the adjusting of Vac and/or D accordingly. The computer may, or may not, be packaged with (or part of) the EFM.

As such, the computer may be programmed to carry out the following method:
(a) place the sensor tip of the EFM at a first distance from the STBA;
(b) increase the AC bias voltage until the sensor sensitivity is equal to or greater than a minimum sensor sensitivity Gmin;
(c) decrease the distance D between the sensor tip and the surface until the sensor sensitivity is equal to or greater than Gmax;
(d) reduce the AC bias voltage and distance D in a manner that keeps the sensor sensitivity close to Gmax until the AC bias voltage is at a desired level; and
(e) commence measurement operations by the EFM with respect to the surface.

The computer may be part of a system for positioning a cantilevered sensor of an EFM relative to a surface. Such a system may have an EFM having (i) a cantilever, (ii) a sensor, (iii) a DC bias voltage generator, (iv) an AC bias voltage generator, and (v) a computer programmed to accept information from the sensor, and to provide control signals to the EFM. FIG. 8 schematically depicts such a system. The programmed computer may be programmed to:
(a) send signals instructing the EFM to place the sensor tip a first distance from the STBA;
(b) send signals instructing the AC bias voltage generator to increase the AC bias voltage until a sensor sensitivity G is equal to or greater than a minimum sensor sensitivity Gmin;
(c) send signals instructing the EFM to decrease the distance D between the sensor tip and the surface until the sensor sensitivity G is equal to or greater than a maximum sensor sensitivity Gmax;
(d) send signals instructing the EFM to reduce the AC bias voltage and distance D in a manner that keeps the sensor sensitivity G close to Gmax until the AC bias voltage is at a desired level; and
(e) send signals instructing the EFM to commence measurement operations by the EFM with respect to the surface once the sensor sensitivity G is close to (or equal to) Gmax and the AC bias voltage is at a desired level.

The computer may be programmed to determine the sensor sensitivity G by:
(a) sending instruction signals to cause the DC bias voltage generator to set a first DC bias voltage to the sensor at a desired voltage (“Vp”) that is greater than 0 Volts;
(b) sending instruction signals to the EFM to cause the sensor to detect the voltage
(c) recording the detected voltage of step “b” as V1;
(d) sending instruction signals to the DC bias voltage generator to cause the DC bias voltage generator to set a second DC bias voltage to the sensor at a desired voltage (“Vn”) that is less than 0 Volts;
(e) sending instruction signals to the EFM to cause the sensor to detect the voltage; (f) recording the detected voltage of step “e” as V2;
(g) determining G, where G equals (V1−V2)÷(Vp−Vn).

U.S. provisional patent application No. 61/593,837 filed on Feb. 1, 2012, discloses additional details about the invention. The disclosure of that patent application is incorporated herein by this reference. To the extent that incorporation by reference is not permitted, Exhibit A hereto is made part of this patent application.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of positioning a cantilevered sensor of an electrostatic force microscope relative to a surface, comprising:
(a) positioning the sensor at a distance D from the surface;
(b) applying to the sensor an AC bias voltage (“Vac”) at an initial desired voltage (“Vd”);
(c) determining the sensor sensitivity (“G”);
(d) comparing G to a minimum sensor sensitivity Gmin;
(e) if G is less than Gmin, then increasing Vac and returning to step “c”;
(f) if Gmin≦G<Gmax, then decreasing D; and returning to step “c”, wherein Gmax is a maximum sensor sensitivity;
(g) if G≧Gmax, then comparing Vac to Vd, and if Vac is determined to be greater than Vd, then decreasing Vac and return to step “c”; and
(h) if G is approximately equal to Gmax and Vac is approximately equal to Vd, then beginning surface measurement operations with respect to the surface using the sensor.

2. The method of claim 1, wherein the sensor sensitivity (“G”) is determined by:
setting a first DC bias voltage to the sensor at a desired voltage (“Vp”) that is greater than 0 Volts;
using the sensor, detecting the voltage V_{ω} and recording the detected voltage as V1;
setting a second DC bias voltage to the sensor at a desired voltage (“Vn”) that is less than 0 Volts; and
using the sensor, detecting the voltage V_{ω} and recording the detected voltage as V2;
determining G, where G equals (V1−V2)÷(Vp−Vn).

3. The method of claim 1, wherein the first distance is selected to be large enough to prevent arcing between the sensor and the surface.

4. The method of claim 1, wherein Gmin is 0.1×10⁻⁴.

5. The method of claim 1, wherein Gmax is selected to be between 0.2×10⁻⁴ and 10×10⁻⁴.

6. A method of positioning a cantilevered sensor of an electrostatic force microscope relative to a surface, comprising:
(a) placing the sensor tip a first distance from the STBA;
(b) increasing the AC bias voltage until a sensor sensitivity G is equal to or greater than a minimum sensor sensitivity Gmin;
(c) decreasing the distance D between the sensor tip and the surface until the sensor sensitivity G is equal to or greater than a maximum sensor sensitivity Gmax;
(d) reducing the AC bias voltage and distance D in a manner that keeps the sensor sensitivity G close to Gmax until the AC bias voltage is at a desired level; and
(e) commencing measurement operations by the EFM with respect to the surface once the sensor sensitivity G is close to Gmax and the AC bias voltage is at a desired level.

7. The method of claim 6, wherein the sensor sensitivity G is determined by:
setting a first DC bias voltage to the sensor at a desired voltage (“Vp”) that is greater than 0 Volts;
using the sensor, detecting the voltage V_{ω} and recording the detected voltage as V1;
setting a second DC bias voltage to the sensor at a desired voltage (“Vn”) that is less than 0 Volts;
using the sensor, detecting the voltage V_{ω} and recording the detected voltage as V2; and
determining G, where G equals (V1−V2)÷(Vp−Vn).

8. The method of claim 6, wherein the first distance is selected to be large enough to prevent arcing between the sensor and the surface.

9. The method of claim 6, wherein Gmin is 0.1×10⁻⁴.

10. The method of claim 6, wherein Gmax is selected to be between 0.2×10⁻⁴ and 10×10⁻⁴.

11. A system for positioning a cantilevered sensor of an electrostatic force microscope (“EFM”) relative to a surface, the system comprising:
(a) an EFM having (i) a cantilever, (ii) a sensor, (iii) a DC bias voltage generator, and (iv) an AC bias voltage generator;
(b) a computer configured to accept information from the sensor, and provide control signals to:
(i) place the sensor tip a first distance from the STBA;
(ii) increase the AC bias voltage until a sensor sensitivity G is equal to or greater than a minimum sensor sensitivity Gmin;
(iii) decrease the distance D between the sensor tip and the surface until the sensor sensitivity G is equal to or greater than a maximum sensor sensitivity Gmax;
(iv) reduce the AC bias voltage and distance D in a manner that keeps the sensor sensitivity G close to Gmax until the AC bias voltage is at a desired level; and
(v) commence measurement operations by the EFM with respect to the surface once the sensor sensitivity G is close to Gmax and the AC bias voltage is at a desired level.

12. The system of claim 11, wherein the computer is programmed to determine the sensor sensitivity G by:
sending signals to cause the DC bias voltage generator to set a first DC bias voltage to the sensor at a desired voltage (“Vp”) that is greater than 0 Volts;
sending signals to cause the sensor to detect the voltage V_{ω};
recording the detected voltage as V1;
sending signals to cause the DC bias voltage generator to set a second DC bias voltage to the sensor at a desired voltage (“Vn”) that is less than 0 Volts;
sending signals to cause the sensor to detect the voltage V_{ω};
recording the detected voltage as V2; and
determining G, where G equals (V1−V2)÷(Vp−Vn).

13. The system of claim 11, wherein the first distance is selected to be large enough to prevent arcing between the sensor and the surface.

14. The system of claim 11, wherein Gmin is 0.1×10⁻⁴.

15. The system of claim 11, wherein Gmax is selected to be between 0.2×10⁻⁴ and 10×10⁻⁴.
